(19) United States
(12) Patent Application Publication
(10) Pub. No.: US 2005/0021810 A1
(43) Pub. Date: Jan. 27, 2005

(54) Remote display protocol, video display system, and terminal equipment

(76) Inventors: Masaya Umemura, Yokosuka (JP); Tsutomu Hara, Yokohama (JP); Kazushige Hiroi, Machida (JP); Kazuo Shigematsu, Yoshikawa (JP); Seishi Hanaoka, Kodaira (JP)

Correspondence Address: MCDERMOTT, WILL & EMERY, 600 13th Street, N.W., Washington, DC, 20005-3096, US

(21) Appl. No.: 10/651,257

(22) Filed: Aug. 29, 2003

(30) Foreign Application Priority Data
Jul. 23, 2003 (JP) 2003-200494

(51) Int. Cl. G06F 15/16

(52) U.S. Cl. 709/231

(57) ABSTRACT

In order to prevent a reduction in frame rate of a reproduced moving picture on the terminal equipment side for performing a display and enable moving picture playback under a simple construction in a remote display technology, either a server or a terminal equipment or both thereof are equipped with router-attached graphics engines. The server draws a window and decoration thereof into a virtual VRAM, calculates the difference in the drawn data, performs a first decode process as a pre-process, adds drawing position information to intermediate data obtained in the first decode process, and transmits moving picture stream data to the terminal equipment. The terminal equipment effects a second decode process used as a post-process on received data, and draws and displays the so-process data in accordance with the drawing position information.

### BACKGROUND OF THE INVENTION

The present invention relates to a remote display technology for displaying display data stored in or generated by a server on the terminal equipment side such as the client side or the like.

As a related art relevant to the present invention, there is known one described in, for example, Japanese Patent Laid-open No. 2001-251594 (Patent Document 1). The same publication describes a technology wherein in order to make it possible to browse or view the screen of each of distant or far-off computer terminals while ensuring security without using dedicated software, an RGB image signal displayed on a display of the computer terminal is converted into an NTSC signal, the input NTSC signal corresponding to the converted output is converted into RGB image data anew, which in turn is encoded by an MPEG image codec/decodec unit, a voice signal from a phone is encoded by a voice signal coding/decoding unit, these outputs of the MPEG image codec/decodec unit and the voice signal coding/decoding unit are multiplexed, and the so-multiplexed signal is transmitted to a network.

For instance, in the related art described in the above-noted publication, the data displayed by the computer terminal is converted into RGB image data under external hardware, which in turn is encoded by the MPEG image codec/decodec unit, followed by its transmission as MPEG image data. The distant terminal equipment having received the data decodes it into the RGB image data again, which is displayed on the display.

When the data displayed by the computer terminal is of the MPEG image data, there is a need to execute three processes of decoding, encoding and decoding that the MPEG image data is decoded to obtain its corresponding RGB image data in the computer terminal, the RGB image data is encoded to obtain its corresponding MPEG image data in the external hardware, and the MPEG image data is decoded to obtain its corresponding RGB image data in the distant terminal equipment.

Problems of the present invention are to, in a remote display technology for displaying image data stored in or generated by a server on the terminal equipment side such as the client side, omit the encoding of the three processes executed in the related art, (1) to make it possible to play back moving pictures by decoding on the sever side and the distant terminal side, and (2) to reduce respective throughputs on the server side and the distant terminal equipment side to thereby enable an improvement in frame rate for displaying moving picture on the distant terminal equipment side, for example.

### SUMMARY OF THE INVENTION

The present invention provides a remote display protocol, a video display system and a terminal equipment which respectively have solved the foregoing problems.

Namely, either one or both of a remote display protocol of the present invention and a server or a terminal equipment for transmitting display data on the basis of the protocol are equipped with router-attached graphics engines.

(1) The present invention provides a remote display protocol wherein in a manner similar to the conventional remote display protocol, a server draws a window and decoration thereof into a virtual VRAM, calculates a difference in the drawn data, adds drawing position information thereto, and transmits the result of addition to the side of a terminal equipment, and the terminal equipment decodes received data and draws and displays the data in accordance with the drawing position information.

(2) In the remote display protocol of the present invention, when RGB image data to be displayed inside the window is of MPEG image data stored in the server, the server does not decode the MPEG image data into the corresponding RGB image data, which is difference-decoded from the RGB image data to inefficient RGB image data. Instead, the server performs a first decode process as a pre-process, adds drawing position information to intermediate data obtained in the first decode process to obtain moving picture stream data, and transmits the moving picture stream data to the terminal equipment. The terminal equipment effects a second decode process used as a post-process on the received moving picture stream data and draws and displays the so-processed data in accordance with the drawing position information. That is, the server performs only part of the decode processing without performing full decoding of MPEG-4, for example, and the terminal equipment on the client side, for example, performs the remaining decode process, and writes data into a VRAM and displays it thereon.

(3) The remote display protocol of the present invention is suitable for use in a video display system for transmitting a video between first and second terminal equipments, i.e., transmitting it from the second terminal equipment to the first terminal equipment and displaying the video on the first terminal equipment. In the video display system, the first terminal equipment notifies information about a resource of its own first graphics engine to the second terminal equipment. In response to this notification, the second terminal equipment makes a comparison between the notified information about the resource of the first graphics engine and information about a resource of its own second graphics engine, based on the notified information, and transmits data at an intermediate stage, processed in accordance with the resource of the second graphics engine in place of the resource of the first graphics engine without using part of the resource of the first graphics engine, on the basis of the result of comparison. The first terminal equipment performs the fist decode process on the original MPEG image data in the form of a substitute for the process of the non-used resource to thereby generate moving picture stream data corresponding to intermediate data and transmits it, and reproduces the resultant video.

(4) The present invention provides a terminal equipment capable of transmitting and receiving moving picture stream data. A CPU included in the terminal equipment encodes a photographed video, a received video or a read video up to intermediate data and transmits the resultant data, and the received moving picture stream data is decoded at a graphics engine.

### BRIEF DESCRIPTION OF THE DRAWINGS

FIG. 1 is a basic configuration diagram of a computer equipped with a router-attached graphics engine according to the present invention;

FIG. 2 is a diagram for describing a process at MPEG-4 playback based on a remote display transfer system according to the present invention;

FIG. 3 is a diagram showing a server and a terminal equipment according to the present invention;

FIG. 4 is a diagram illustrating the state of communications between the server and terminal equipment shown in FIG. 3;

FIG. 5 is a diagram showing an example of the display of display contents of a portable terminal equipment on a PC screen;

FIG. 6 is a diagram illustrating an example of the display of the display contents of the portable terminal equipment on a TV screen;

FIG. 7 is a diagram depicting an example of the display of a playback screen of a DVD player on the screen of the portable terminal equipment;

FIG. 8 is a diagram showing a configuration example of a liquid crystal controller chip equipped with a router-attached graphics engine according to the present invention;

FIG. 9 is a diagram illustrating an example of a system liquid crystal equipped with a router-attached graphics engine according to the present invention; and

FIG. 10 is a diagram showing a configuration example of a computer equipped with no router-attached graphics engine.

### DETAILED DESCRIPTION OF THE EMBODIMENTS

Embodiments of the present invention will hereinafter be described with reference to the accompanying drawings.

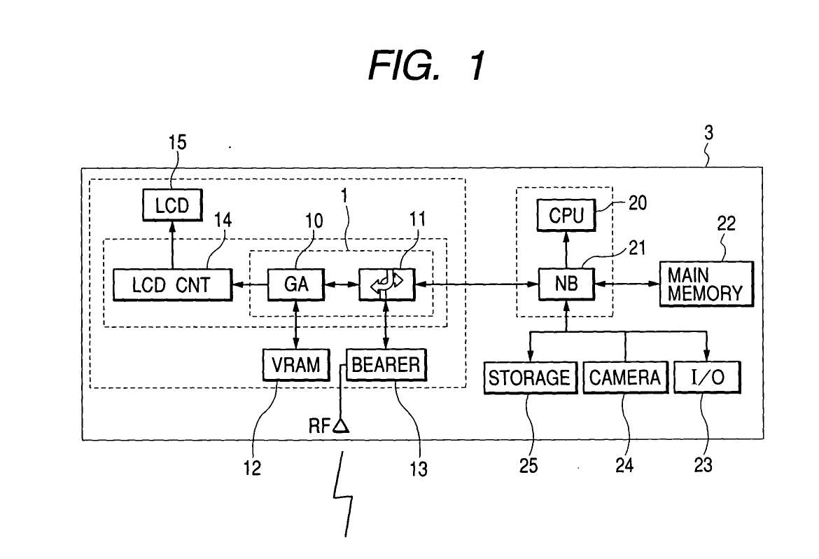

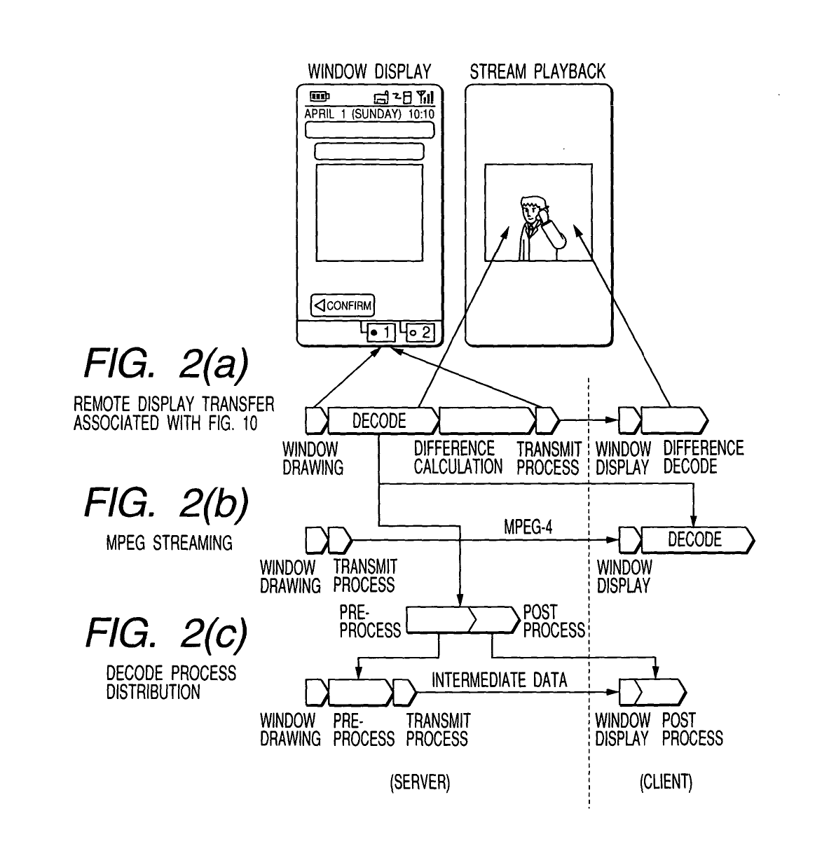

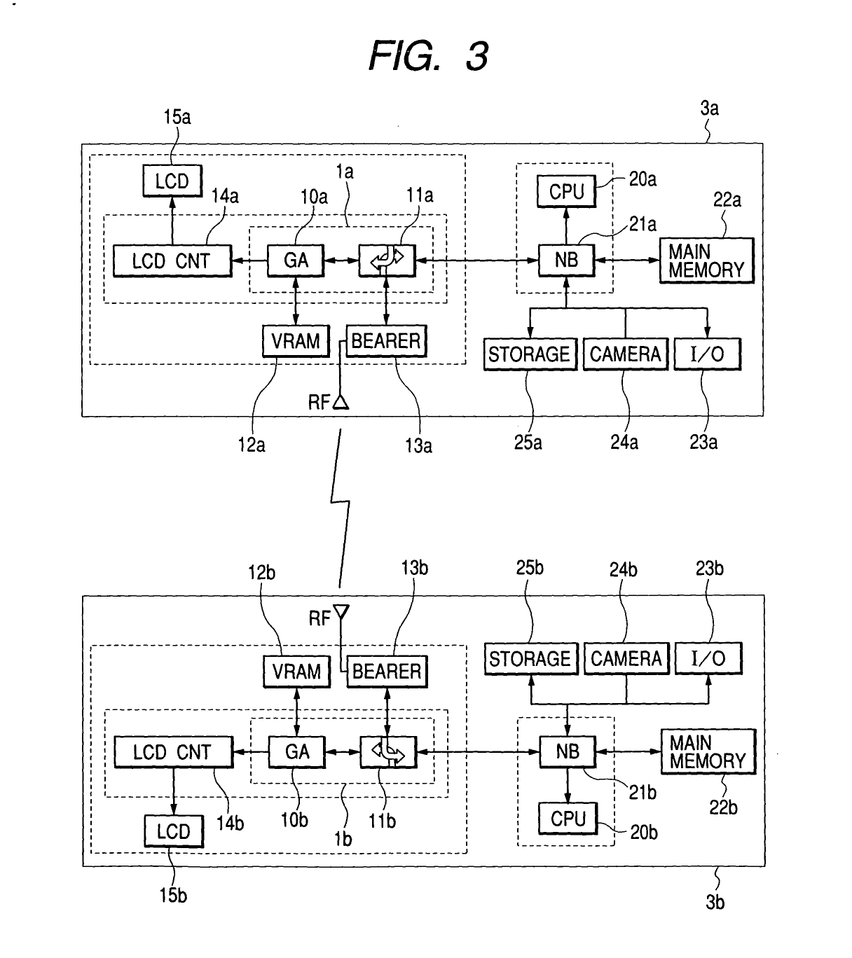

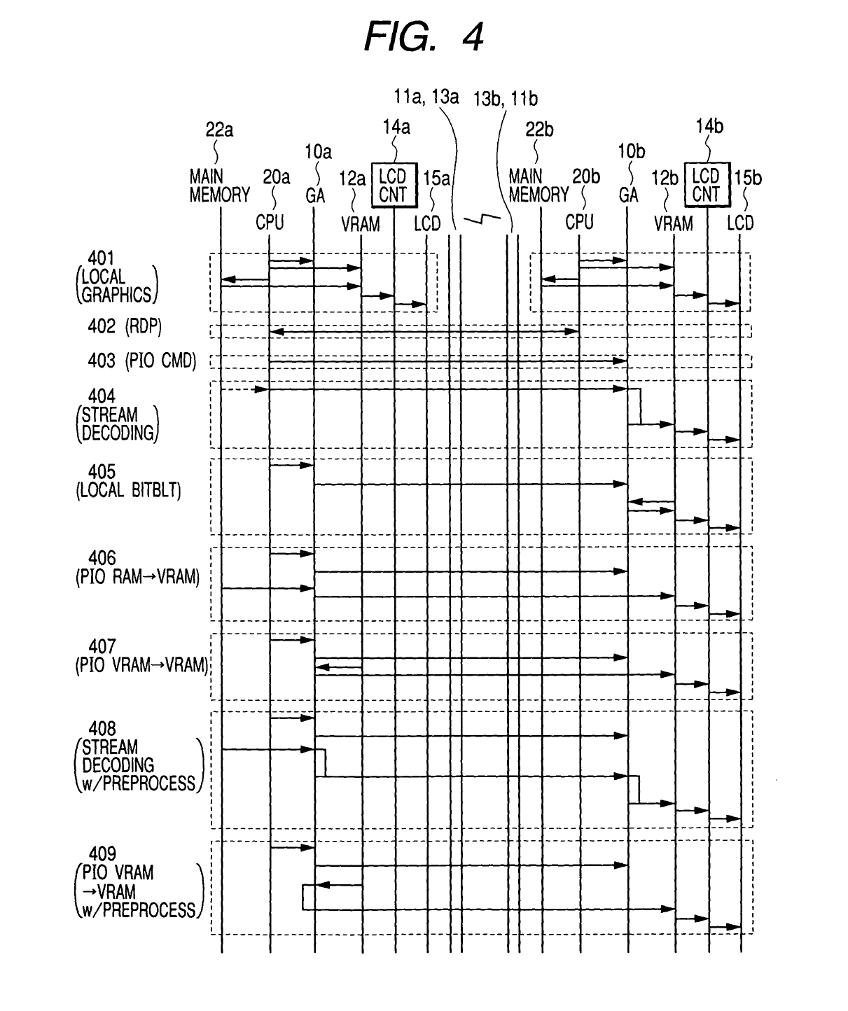

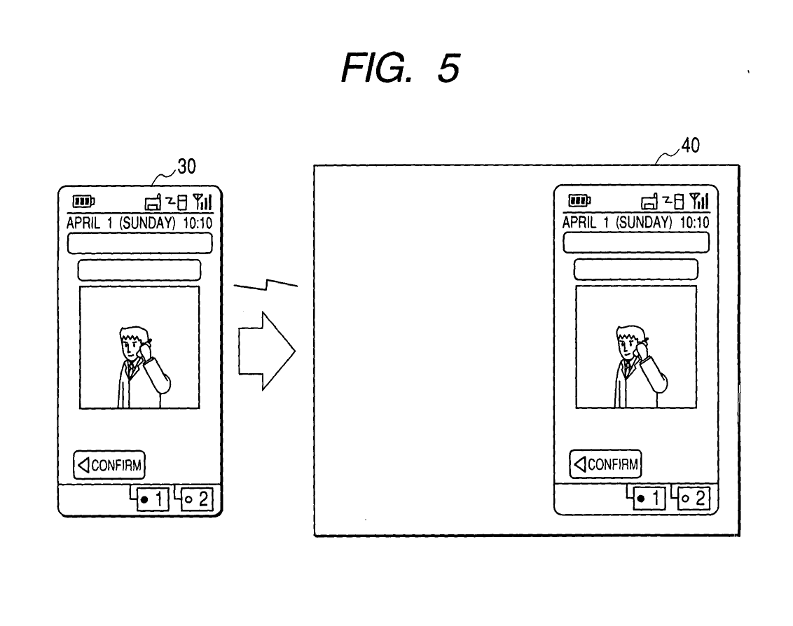

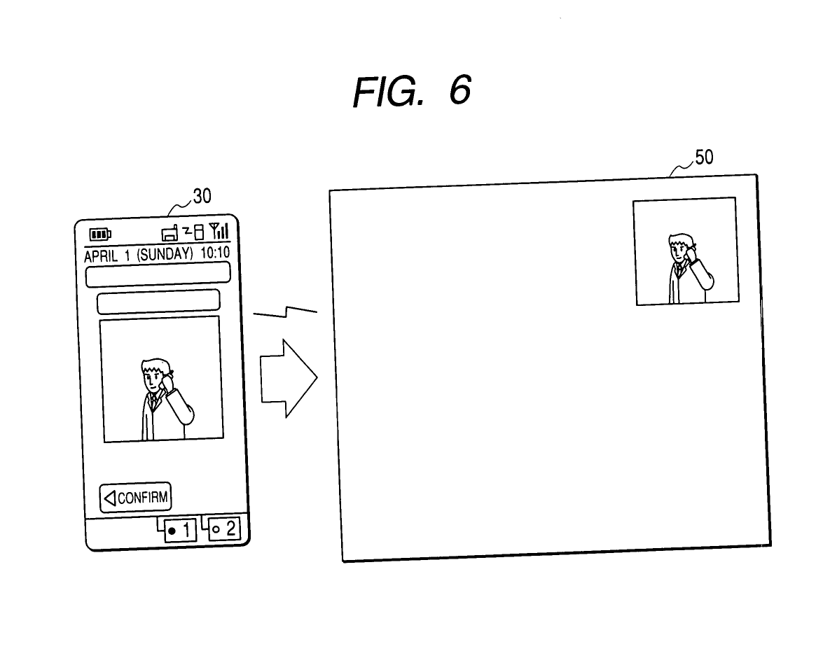

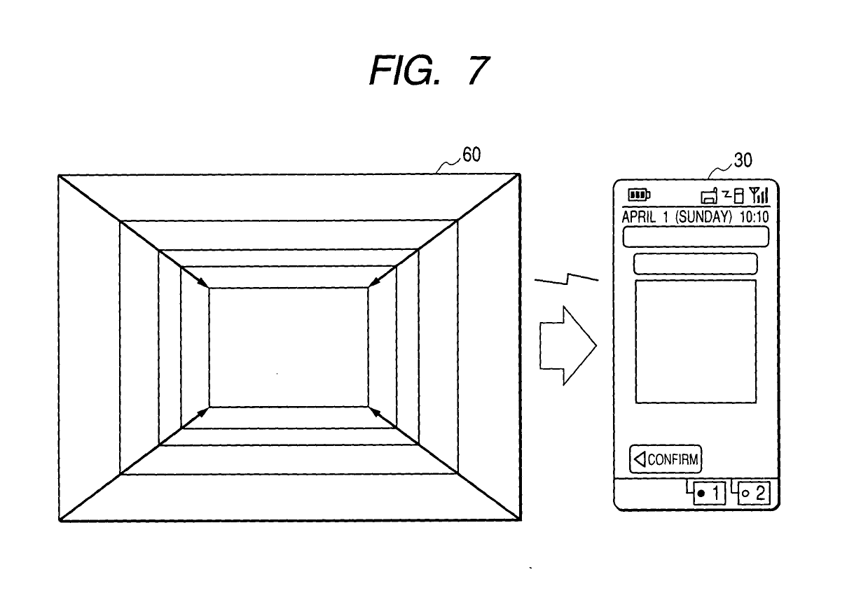

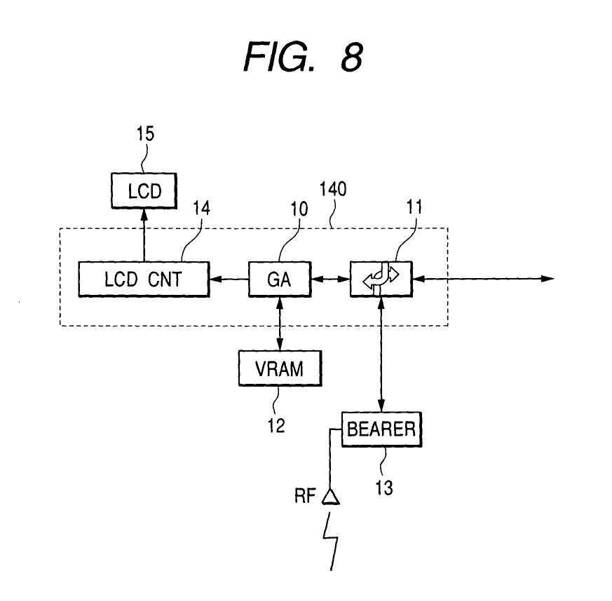

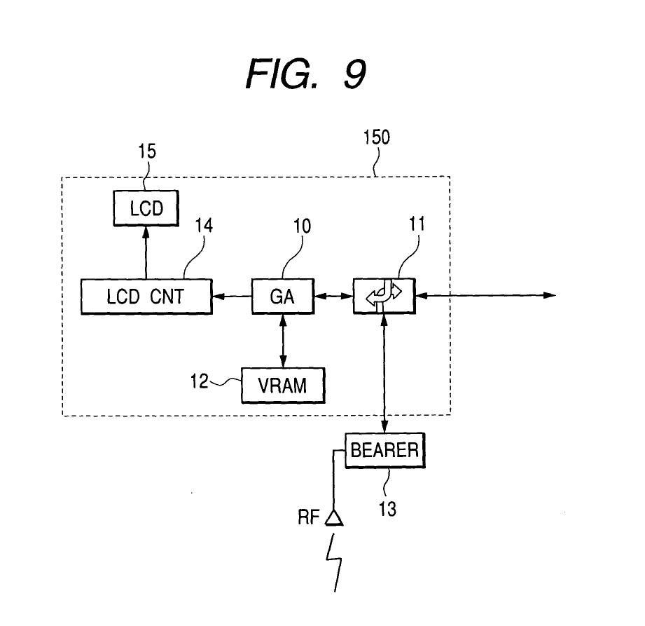

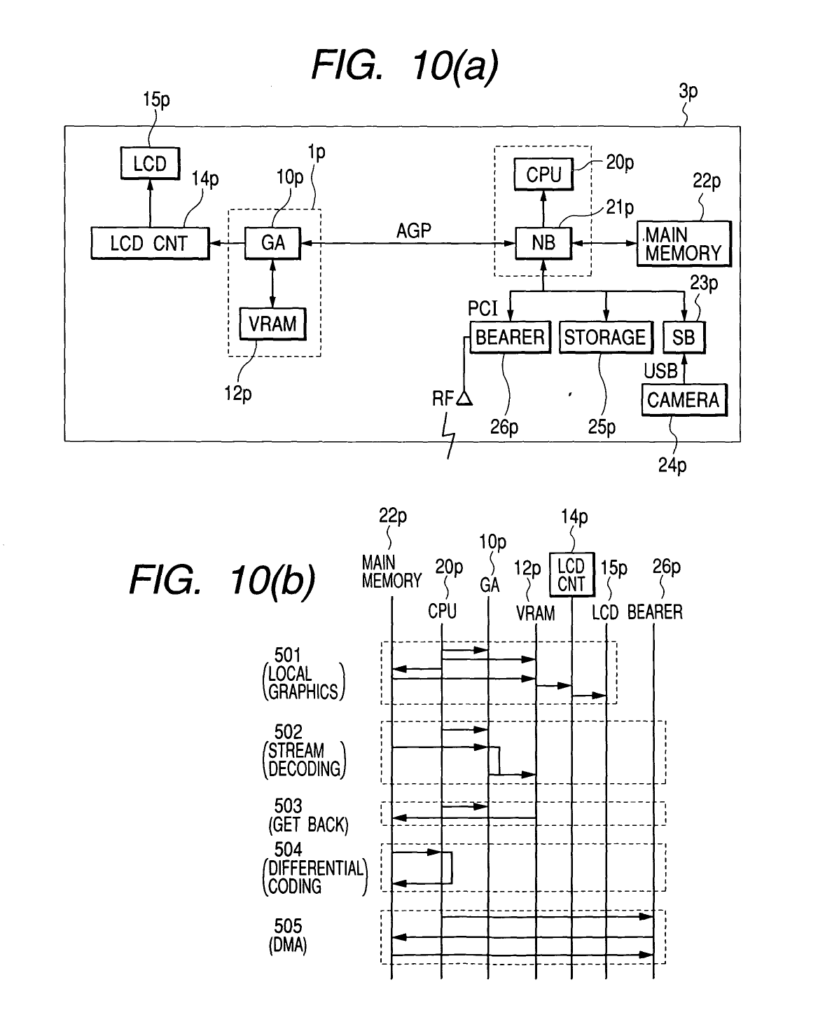

FIGS. 1 through 10 are explanatory diagrams of the embodiments of the present invention. FIG. 1 is a basic configuration diagram of a computer equipped with a router-attached graphics engine according to the present invention, FIG. 2 is a diagram for describing a process at MPEG-4 playback based on a remote display transfer system, FIG. 3 is a diagram showing a server and a terminal equipment according to the present invention, FIG. 4 is a diagram illustrating the state of communications between the server and terminal equipment shown in FIG. 3, FIG. 5 is a diagram depicting a display example in which display contents of a portable terminal equipment are displayed on the screen of a personal computer (hereinafter called “PC”), FIG. 6 is a diagram showing a display example in which the display contents of the portable terminal equipment are displayed on the screen of a television set (hereinafter called “TV”), FIG. 7 is a diagram illustrating a display example in which a playback screen of a DVD player is displayed on the screen of the portable terminal equipment, FIG. 8 is a diagram showing a configuration example of a liquid crystal controller chip equipped with a router-attached graphics engine according to the present invention, FIG. 9 is a diagram depicting an example of a system liquid crystal equipped with a router-attached graphics engine according to the present invention, and FIG. 10 is a diagram showing a configuration example of a computer equipped with no router-attached graphics engine, respectively.

In FIG. 1, reference numeral 1 denotes a router-attached graphics engine, reference numeral 10 denotes a graphics engine, reference numeral 11 denotes a router, reference numeral 12 denotes a VRAM, reference numeral 13 denotes a bearer chip such as a wireless LAN module, reference numeral 14 denotes a liquid crystal controller, reference numeral 15 denotes a liquid crystal displayer, reference numeral 20 denotes a CPU, reference numeral 21 denotes a North bridge, reference numeral 22 denotes a main memory, reference numeral 23 denotes an I/O, reference numeral 24 denotes a camera used as an I/O, reference numeral 25 denotes a storage used as an I/O, and reference numeral 3 denotes a computer used as a terminal equipment.

The CPU 20, the main memory 22, the I/O 23, the camera 24, the storage 25, and the like are connected to the North bridge 21. The I/O 23, the camera 24, and the storage 25 are connected to the North bridge 21 via an I/O bus. The router-attached graphics engine 1 is connected to a graphic bus. The router-attached graphics engine 1 comprises the graphics engine 10 and the router 11. The VRAM 12 is connected to the graphics engine 10 and used as a frame memory, a computing memory or a communications buffer. The North bridge 21, the graphics engine 10, and the bearer chip 13 are connected to the router 11. The router 11 performs the transfer of information among these. That is, the router 11 performs an PIO access from the CPU 20 to the graphics engine 10 and VRAM 12, a DMA access of the bearer chip 13 to the main memory 22, a relay of an I/O-to-I/O transfer from the graphics engine 10 to the bearer chip 13, etc. The liquid crystal controller 14 is further connected to the graphics engine 10. The liquid crystal controller 14 reads bit map data of the frame memory and outputs it to the liquid crystal displayer 15 side. The liquid crystal displayer 15 performs an image display, based on the bit map data.

FIG. 2 is a diagram for describing processing operations of a server and a client-side terminal equipment at MPEG-4 playback based on the remote display transfer system according to the present invention.

As the remote display transfer system according to the present invention, there are known an MPEG streaming system (FIG. 2(b)), and a decode-process distribution system (FIG. 2(c)). In the MPEG streaming system, window graphics drawing is effected on a virtual VRAM and difference-encoded, which resultant one is transmitted to the client-side terminal equipment in conjunction with streaming data of MPEG-4. The client-side terminal equipment decodes data about the difference-encoded window, decodes the data of MPEG-4, and displays the individually-decoded data together. In the decode-process distribution system, the MPEG-4 decoding that the MPEG streaming system has performed through the use of the client-side terminal equipment, is sorted into a pre-process and a post-process, and the pre-process is performed by the server. Attendant information is added to the data obtained from the result of the pre-process as a tag, which is transmitted to the client-side terminal equipment as intermediate data. The client-side terminal equipment decodes the received data of difference-encoded window, post-processes the intermediate data in accordance with the tag to thereby complete the MPEG-4 decoding, and displays the individually-decoded data together. The tag information indicates parameters of MPEG-4 necessary for the post-process, such as quantization coefficients, serial numbers or display positions of macro blocks; a process to be carried out next, e.g., iDCT (inverse Discrete Cosine Transform) of data cut out to the macro blocks; etc.

A description will next be made of a remote display protocol between information terminals and its operation, especially, a linkage process of a graphics engine based on the decode-process distribution system corresponding to the remote display transfer system according to the present invention.

FIG. 3 is a diagram showing a server and a terminal equipment according to the present invention, and FIG. 4 is a diagram illustrating the state of communications between the server and the terminal equipment shown in FIG. 3.

In FIG. 3, reference numeral 3a denotes a server (server information terminal), and reference numeral 3b denotes a terminal equipment on the client side. In FIG. 4, reference numeral 401 denotes graphics drawings at the respective information terminals, reference numeral 402 denotes a remote display protocol between the server 3a and the client-side terminal equipment 3b, reference numeral 403 denotes a command sent from the server 3a to a graphics engine 10b of the client-side terminal equipment 3b, reference numeral 404 denotes delivery (casting) of a moving picture stream from the server 3a to the client-side terminal equipment 3b and graphic drawing thereof, reference numeral 405 denotes a BitBlt(Bit Block Transfer) process on a VRAM 12b of the client-side terminal equipment 3b by an instruction issued from the server 3a, reference numeral 406 denotes a memory copy from a main memory 22a of the server 3a to a VRAM 22b of the client-side terminal equipment 3b according to the server's instruction, reference numeral 407 denotes a memory copy from a VRAM 12a of the server 3a to the VRAM 12b of the client-side terminal equipment 3b in accordance with the instruction of the server 3a, reference numeral 408 denotes mid decoding (generation of data at intermediate stage) by the graphics engine 10a on the server 3a side, delivery thereof to the client-side terminal equipment 3b, and decoding and representation thereof by the graphics engine 10b of the client-side terminal equipment 3b, and reference numeral 409 denotes processing of data stored in the VRAM 12a on the server 3a side by the graphics engine 10a of the server 3a, and writing thereof into the VRAM 12b of the client-side terminal equipment 3b and its indication.

In FIGS. 3 and 4, the server 3a and the client-side terminal equipment 3b perform communications between bearer chips 13a and 13b corresponding to each wireless LAN. The server 3a transmits information about resolution and the number of colors to the client-side terminal equipment 3b according to the remote display protocol 402 to establish a session. Immediately after the session is started, the server 3a acquires information about the model number of the graphics engine 10b of the client-side terminal equipment 3b, the capacity of the VRAM 12b, etc. and isolates a process that can be taken over by the graphics engine 10a of the server 3a.

In the server 3a and the client-side terminal equipment 3b, the client-side terminal equipment 3b transmits resolution and the number of colors, and information about an input device (I/O 23b) such as a keyboard to the server 3a in accordance with the remote display protocol 402 to thereby establish the session, whereby the relationship between the server and its corresponding client is established (402).

A CPU 20a of the server 3a effects the setting of a graphics drawing area to the graphics engine 10b of the client-side terminal equipment 3b and obtains a response (403). Subsequently, the CPU 20a opens the window according to the resolution and the number of colors required upon establishment of the session and performs decorations such a button, etc.

The server 3a directly sends moving picture stream data of MPEG-4 or the like to the graphics engine 10b of the client-side terminal equipment 3b. The graphics engine 10b decodes it and a liquid crystal displayer 15b displays the result of decoding (404).

When a change occurs in the position of its display by the window operation of the I/O 23b of the server 3a, the CPU 20a of the server 3a transmits a BitBlt command to the graphics engine 10b of the client-side terminal equipment 3b. The graphics engine 10b reads the data on the VRAM 12b according to the BitBlt command and computes it, and writes the data into a designated address, thereby changing a display position of an object on the window or window pane, which has been displayed on the liquid crystal displayer 15b (405).

The server 3a writes the bit map data developed into the main memory 22a into the VRAM 12b of the client-side terminal equipment 3b in the form of the size and style whose font has been designated by the CPU 20a thereby to display character information (406).

The server 3a instructs the graphics engine 10b of the client-side terminal equipment 3b to read a thumbnail image and an icon stored in the VRAM 12a. The graphics engine 10b reads data at a designated address of the VRAM 12a in accordance with its instruction, and writes the data into the VRAM 12b and displays it thereon (407).

The CPU 20a encodes a moving picture of the camera 24a according to another process and delivers the moving picture stream data stored in the main memory 22a to the client-side terminal equipment 3b. The CPU 20a of the server 3a instructs the graphics engine 10a and the graphics engine 10b of the client-side terminal equipment 3b to perform data playback. The graphics engine 10a of these engines performs partial decoding to generate data at an intermediate stage and transmits the data to the graphics engine 10b. The graphics engine 10b having received the data therein performs the remaining decoding, and writes the so-decoded data into the VRAM 12b and displays it on the liquid crystal displayer 15b (408). The data at the intermediate stage is for example, data set for each block unit of MPEG-4. The graphics engine 10b performs only the last iDCT (inverse Discrete Cosine Transform).

Also the CPU 20a of the server 3a issues an instruction to the graphics engine 10a in order to cause the graphics engine 10a to display the information already displayed on the liquid crystal displayer 15a on the liquid crystal displayer 15b of the client-side terminal equipment 3b. The graphics engine 10a transfers an instruction (writing into designated address/overwrite prohibition) to the graphics engine 10b of the client-side terminal equipment 3b. The graphics engine 10a processes data on the VRAM 12a, i.e., performs a polygon process and rendering of a 3D image, for example to thereby generate bit map data, and writes the data into the VRAM 12b of the client 3b and displays it thereon.

In accordance with a series of instructions issued from the CPU 20a, the graphics engines 10a and 10b process and display data in conjunction with each other in the case of a moving picture streaming and a 3D display.

A description will next be made of a case in which a moving picture stream is delivered, decoded and displayed among a portable terminal equipment such as a cellular phone, a PC, a TV and a DVD player.

FIG. 5 shows a display example in which display contents of the portable terminal equipment are displayed on a PC screen, FIG. 6 illustrates a display example in which the display contents of the portable terminal equipment are displayed on a TV screen, and FIG. 7 depicts a display example in which a playback screen of the DVD player is displayed on the screen of the portable terminal equipment, respectively.

In FIG. 5, reference numeral 30 denotes the display screen of the portable terminal equipment, and reference numeral 40 denotes the PC's screen that displays the display contents of the portable terminal equipment. In FIG. 6, reference numeral 50 denotes the TV screen that displays the display contents of the portable terminal equipment. In FIG. 7, reference numeral 60 denotes a display screen of the portable DVD player, and reference numeral 30 denotes the screen of the portable terminal equipment, which displays DVD's contents decoded by the portable DVD player and the portable terminal equipment in conjunction with each other.

Assuming in FIG. 5 that a user is making a videophone call through the portable terminal equipment to just before the next instructions. Let's consider that a module for a wireless LAN is connected to a graphics engine and the portable terminal equipment is able to communicate with each PC located therearound. The user performs the establishment of each session between the portable terminal equipment and each PC located therearound on the basis of a remote display protocol. When the session is established, the screen 30 of the portable terminal equipment appears at part of the PC screen 40. Thereafter, the user is able to make a videophone call while seeing the larger and wider PC screen 40 as well as the screen 30 of the portable terminal equipment.

Before the session establishment, the graphics engine of the portable terminal equipment is performing encoding and decoding of a moving picture. The portable terminal equipment has no VRAM corresponding to a large screen like that of the PC. Therefore, after the session establishment, the portable terminal equipment transmits moving picture data to the corresponding PC, where it performs decode and enlarge processing to realize an enlarged display. By pressing vertical and horizontal keys of the portable terminal equipment, the display of the portable terminal equipment, which is represented on the PC, is shifted in the vertical and horizontal directions on the screen 40 of the PC.

Even after the session establishment, the OS or device driver of the PC sends a key map to the portable terminal equipment on the basis of the remote display protocol to key-bind a ten key of a keyboard to the virtual I/O of the portable terminal equipment, for example. While the session is being continued, the keyboard of the PC enables dialing or the like subsequently.

In FIG. 6, a user makes a videophone call through the use of the portable terminal equipment to just before the next instructions. Now consider that the portable terminal equipment is equipped with a router-attached graphics engine, and a module for a wireless LAN is connected to the graphics engine. Also consider that even each TV located around the user, or an STB (Set Top Box) connected to the TV is equipped with a router-attached graphics engine, and it is able to communicate with the portable terminal equipment of the user. The user performs the establishment of a session between the portable terminal equipment and each STB located therearound on the basis of a remote display protocol. When the session is established, the screen 30 of the portable terminal equipment appears at part of the TV screen 50. Thereafter, the user makes a videophone call while seeing the larger and wider TV screen 50 as well as the screen 30 of the portable terminal equipment. During this session, the STB corresponds to a program stream and a transport stream of MPEG-2 but does not correspond to the playback of MPEG-4. Therefore, the portable terminal equipment dequantizes a stream of MPEG-4 and decodes a motion vector to generate data at an intermediate stage and sends it to the STB. The STB converts data set for each block unit after the de-quantization into bit map data in accordance with the inverse discrete cosine transform and performs memory reading and computing in accordance with the motion vector to thereby realize the playback of moving pictures. By pressing vertical and horizontal keys of the portable terminal equipment, the display 30 of the portable terminal equipment, which is represented on the TV screen 50, is shifted in the vertical and horizontal directions on the screen 50 of the TV.

After the establishment of the session from the portable terminal equipment, the OS of the STB sends a key map corresponding to a soft keyboard displayed on the TV screen 50 to the portable terminal equipment on the basis of the remote display protocol to effect key-binding on a virtual I/O of the cellular phone. Subsequently, while the session is being continued, the soft keyboard is displayed on the TV screen 50 and dialing or the like is hence enabled through the soft keyboard.

Even in FIG. 7, assume that the user's portable terminal equipment is equipped with a router-attached graphics engine, and a module for a wireless LAN is connected to the graphics engine. Also assume that even the DVD player located around the user or an STB (Set Top Box) connected with the DVD player is equipped with a router-attached graphics engine, and it is able to communicate with the portable terminal equipment of the user. The user performs the establishment of a session between the portable terminal equipment and each STB located therearound on the basis of a remote display protocol. When the session is established, an image reproduced by the DVD, a top menu at the start of its playback, etc. are displayed on the display screen 60. Substantially simultaneously, the graphics engine mounted in the DVD player or STB performs an image scale-down process, e.g., reduces a 640×320 image with 525i to a QCIF size, converts a frame rate to 15 frames/s, and transmit it to the portable terminal equipment through the wireless LAN. The user presses a button or key associated with each icon on the screen 30 of the portable terminal equipment to perform playback control.

Further, mapping information about cross-direction buttons and keys of the portable terminal equipment are exchanged and registered between the portable terminal equipment and the DVD player upon establishment of the session on the basis of the remote display protocol. Therefore, a menu screen of a BML-described DVD is switched and selected by pressing down, e.g., the cross-directional button or key of the portable terminal equipment to thereby instruct the DVD player to perform the corresponding operation.

In the present configuration, the DVD player performs a process inherent in MPEG-2 as a pre-process, so the portable terminal equipment may perform only a process common to MPEG-2 and MPEG-4. Thus, the portable terminal equipment capable of performing only the playback of MPEG-4 is able to carry out the playback of MPEG-2.

According to the embodiments described with reference to FIGS. 1 through 7, the speeding up of streaming playback of MPEG-4 or the like that has been brought to a low frame rate in the conventional remote display transfer system, and a high frame rate are enabled. The server side needs not to have to decode MPEG-4 streaming data and difference-encode of the image whi is decoded from MPEG-4 streaming data, and the capacity of the main memory and the load on the CPU can be reduced. It is also possible to reduce the numberof a memory access to the virtual VRAM on the main memory as reality. Further, a reduction in the occupation time of a memory bus, a reduction in the number of operations of a context switch of a cache memory, etc. are enabled. It is furthermore possible to lessen the influence exerted on other process executed by the CPU and shorten the time required to execute other process. In addition, the server and client-side terminal equipment sort decoding processing of MPEG-4 into a pre-process and a post-process through the router-attached graphics engines, thereby making it possible to strike a load balance between the server and the client-side terminal equipment. Also increasing the amount of the pre-process enables playback of moving pictures by the client-side terminal equipment low in processing performance. By defining the pre-process as the process inherent in MPEG-4 and defining the post-process as the process common to MPEG-2 and MPEG-4, for example, even each terminal capable of performing only the playback of MPEG-2 is able to carry out the playback of MPEG-4.

FIG. 8 is a diagram showing a configuration example of a liquid crystal controller chip equipped with a router-attached graphics engine.

In the liquid crystal controller chip shown in FIG. 8, a graphics engine 10 and a liquid crystal controller 14 are provided within the same chip and share the use of a VRAM 12. Owing to such a configuration, the capacities of working area RAMs, which have heretofore been held in a liquid crystal controller and a graphics engine individually, can be reduced. The timing provided to read the VRAM 12 by the liquid crystal controller 14 is already known, and the scheduling of read/write of a bearer chip 13, a CPU 20 and the graphic engine 10 becomes easy.

FIG. 9 is a diagram showing a configuration example of a system liquid crystal equipped with a router-attached graphics engine according to the present invention.

In FIG. 9, the system liquid crystal includes a graphics engine 10, a router 11 and a liquid crystal controller 14 mounted on the back of a liquid crystal panel (not shown) of a liquid crystal displayer 15 together with a liquid crystal drive LSI (not shown). Since the liquid crystal drive LSI can easily determine even the presence or absence of rewriting of a VRAM 12, a rewritten or reprogrammed area, etc., display contents remain unchanged in a non-rewritten area. In the case of p and b frames of MPEG-1 and 2, and a pVOP and a bVOP of MPEG-4 in particular, each macroblock in a stream is drawn on an area designated by its positional information, no rewriting is effected on areas where no macroblocks are drawn in a display area, and the immediately preceding screen, i.e., the immediately preceding frame data is held and displayed.

Since the VRAM 12 and each individual pixel in the display area are grasped by the liquid crystal drive LSI, the display contents remain unchanged unless the rewriting is done. When no display contents are changed, extra processing and consumption of power can be avoided. Since the bearer chip 13 causes bit map data to directly flow into the VRAM 12 and allows a command and a moving picture stream of MPEG or the like to directly flow into the graphics engine 10, high-speed drawing and a high-speed display are enabled.

FIG. 10 is a comparison explanatory diagram of the invention of the present application and is a diagram showing a basic configuration example ((a)) of a computer equipped with no router-attached graphics engine, and its operation ((b)).

When a remote display based on a serer and a client-side terminal equipment is constituted by the computer having such a configuration as shown in FIG. 10, the server writes the result of window drawing and decode processing into a main memory 22 assigned to a virtual VRAM and thereafter performs a difference calculation and transmits the result of its calculation to the client-side terminal equipment. The client-side terminal equipment displays a window and a moving picture stream as a result of difference decoding (FIG. 2 (a)). In the server, for example, a North bridge 21p is connected to a CPU 20p, a bearer chip 26p such as a Wireless LAN is connected to a main memory 22p and a PCI bus. A video card is equipped with a graphics engine 10p, which is connected to the North bridge 21p via an AGP bus. A virtual VRAM based on a display size and the number of colors for the client-side terminal equipment is prepared on the server side. The server effects graphics drawing on the virtual VRAM. A display cycle (read cycle) exists in the virtual VRAM. Each time the display cycle proceeds by one cycle, the difference in drawing data of the virtual VRAM is calculated and the difference data is transmitted to the client-side terminal equipment, so that the graphics drawing on the client-side terminal equipment is carried out.

Upon playback of moving picture data, in the case of MPEG-4, for example, the server (personal computer 4) performs decoding of MPEG-4 and effects graphics drawing on the virtual VRAM on the main memory 22. A display cycle exists even in the virtual VRAM independent of the frame rate of MPEG-4 and irrespective of it. Each time the display cycle proceeds by one cycle even during MPEG-4 decoding, the CPU 20p calculates the difference in drawing data of the virtual VRAM on the main memory 22p (504), and transmits the difference data to the client-side terminal equipment via the bearer chip 26p (505), thereby performing the graphics drawing of the client-side terminal equipment.

In a portion of graphics work station, the graphics engine 10p performs the decoding of MPEG-4 in place of the CPU 20p by making use of the function of getting back data subjected to rendering or decoding by the video card connected to the AGP (502). The graphics engine 10p temporarily stores the data in its corresponding VRAM 12p and gets the data back to the main memory 22p via the AGP bus anew (503). The CPU 20p calculates the difference in drawing data of the virtual VRAM on the main memory 22p (504) and transmits the difference data to the client-side terminal equipment via the bearer chip 26p (505).

When the playback of MPEG-4 is performed according to the remote display transfer system in the configuration of FIG. 10, the decoding is performed on the server side and the difference decoding is performed anew, thereby increasing overhead for processing. Therefore, there is a possibility that the client-side terminal equipment will be able to carry out reproduction only at a low frame rate equivalent to about 2 frames/s. According to the invention of the present application described with reference to FIGS. 1 through 9, this point of view can also be resolved.

According to the configuration of the embodiment described in each of FIGS. 1 through 9, the client-side terminal equipment is able to perform moving picture reproduction under a simple construction in which the need for external hardware is eliminated, for example. The frame rate of each reproduced moving picture can also be prevented from being reduced.

According to the present invention, the terminal equipment side is capable of reproducing moving pictures under a simple construction in the remote display technology. A reduction in the frame rate of each reproduced moving picture can be also prevented.

The present invention can be carried out even in other various embodiments without departing from the spirit or main features thereof. For that reason, the foregoing embodiments are merely illustrations of the present invention in all respects and should not be construed in a limiting sense. The scope of the present invention is shown by the appended claims. Further, any modifications and changes that belong to the equivalent scope of claims are all within the scope of the present invention.

1. A remote display protocol for displaying moving picture stream data stored in a server or generated by the server on the side of a terminal equipment,
wherein said server draws a window and decoration thereof into a virtual VRAM, calculates a difference in the drawn data, performs a first decode process as a pre-process, adds drawing position information to intermediate data obtained in the first decode process, and transmits the result of said addition to the terminal equipment side, and
wherein said terminal equipment performs a second decode process as a post-process after reception of the moving picture stream data, and draws and displays the data inside the window in accordance with the drawing position information.

2. The remote display protocol according to claim 1, wherein said server tag-adds information necessary for the second decode process to the intermediate data and transfers the so-obtained data to the terminal equipment side in sequence.

3. The remote display protocol according to claim 2, wherein the tag-added information is a parameter for the stream data obtained in the first decode process.

4. The remote display protocol according to claim 2, wherein the tag-added information is information for identifying a procedure for a process completed in the first decode process, or information for identifying a procedure for a process started in the second decode process.

5. The remote display protocol according to claim 1, wherein said server and said terminal equipment are respectively capable of swapping information about resources of graphics engines included therein with each other.

6. The remote display protocol according to claim 5, wherein either one or both of said server and said terminal equipment perform either one or both of the first decode process and the second decode process, based on the swapped information about the resources of the graphics engines.

7. The remote display protocol according to claim 6, wherein said server transmits the intermediate data obtained in the first decode process to the terminal equipment side.

8. The remote display protocol according to claim 1, wherein when a session is established, said server instructs the terminal equipment side to ensure a condition for each display resource.

9. The remote display protocol according to claim 1, wherein upon session establishment, said terminal equipment discloses a condition for each display resource and information of input means to said server.

10. A video display system for transmitting and receiving a video between first and second terminal equipments and displaying the same, comprising:
said first terminal equipment that notifies information about a resource of its own first graphics engine to said second terminal equipment; and
said second terminal equipment that draws a comparison between the notified information about the resource of the first graphics engine and information about a resource of its own second graphics engine, based on the notified information, acts for above process in accordance with the resource of the second graphics engine in place of the resource of the first graphics engine without using part of the resource of the first graphics engine, and transmits processed data at an intermediate stage,
wherein said first terminal equipment having deactivated the part of the resource of the first graphic engine processes the data at the intermediate stage in accordance with non-deactivated resource to playback the video.

11. The video display system according to claim 10, wherein the information about the resources of the first and second graphics engines are information of memories placed under the control of the graphics engines.

12. The video display system according to claim 10, wherein the information about the resources of the first and second graphics engines are information about operating frequencies of the resources of the graphics engines, information about computing power set every functions of computing units of the graphics engines, or information about manufacturers of the graphics engines and the types of the graphics engines.

13. A video display system for transmitting and receiving videos among a plurality of terminal equipments and displaying the same,
wherein said terminal equipments respectively have host CPU, graphics engines, a plurality of bearer chips, storages and input/output units, said graphics engines being equipped with routers thereinside and being connected to the plurality of bearer chips and the host CPU, respectively.

14. The video display system according to claim 13, wherein the plurality of terminal equipments include a first terminal equipment that transmits a video prepared by its own host CPU via the router of its own first graphics engine and a bearer connected to the first graphics engine, and a second terminal equipment which has a bearer connected to its own second graphics engine, said bearer receiving a video sent from the second terminal equipment, and directly writes the received video into the first graphics engine via the router of the first graphics engine.

15. The video display system according to claim 14, wherein the video prepared by the host CPU of the first terminal equipment is a video encoded by the host CPU.

16. The video display system according to claim 14, wherein said first graphics engine transmits a read command to the bearer connected to the first graphics engine via the router of the first graphics engine, and the bearer reads the transmitting video from the first graphics engine or a VRAM included in the first graphics engine in accordance with the read command.

17. The video display system according to claim 14, wherein when the bearer connected to the second graphics engine has received a video, the router of the second graphics engine analyzes a leading portion of the video and writes the result of analysis into a CPU or a main memory of the second terminal equipment, or the second graphics engine or a VRAM included in the second graphics engine, which is set as a transfer destination.

18. A terminal equipment for transmitting and receiving moving picture stream data, comprising:
a CPU,
wherein said CPU encodes a photographed video, a received video or a read video, adds a command of a graphics engine of a display unit or an op code thereof indicative of a resource necessary for decoding to the encoded video, transmits the same, and decodes received data in accordance with the command or the op code at the graphics engine of the display unit.
